(19) United States
(12) Patent Application Publication
(10) Pub. No.: US 2005/0263010 A1
(43) Pub. Date: Dec. 1, 2005

(54) Barbecue Top Cooker

(76) Inventors: John H. Fincher, Canton, GA (US); Van J. McAlister, Ball Ground, GA (US)

Correspondence Address: JOHN H. FINCHER, 155 GOLF COURSE ROAD, CANTON, GA, 30114, US

(21) Appl. No.: 10/857,091

(22) Filed: May 28, 2004

(51) Int. Cl. A47J 37/10

(52) U.S. Cl. 99/422

(57) ABSTRACT

The Barbecue Top Cooker is a new device in cooking or grilling foods that covers foods as they cook on the grill surface or cooking surface that increases moisture and flavor of the cooked foods and provides a barrier from flying insects as food is cooked on the grill surface or cooking surface. The Barbecue Top Cooker, made of heatable food cooking acceptable material, forms a lid or top over foods as they cook on the grill or cooking surface. This device increases temperatures, maintains more constant and uniform temperatures, and decreases the amount of viable bacteria of foods cooked with it.

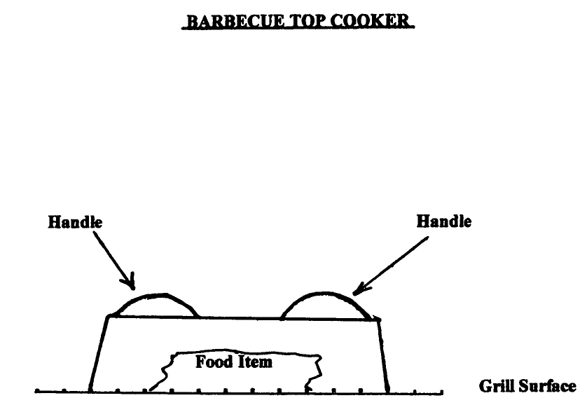

### CROSS REFERENCE TO RELATED APPLICATIONS

Not Applicable

### STATEMENT REGARDING FEDERALLY SPONSORED RESEARCH OR DEVELOPEMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

Various cooking devices have been invented under various patents too numerous to list. The Barbecue Top Cooker is a cooking device to be used in conjunction with a grill or other cooking device to allow a person to prepare delicious food items on a grill easily, with more flavor, and with less possibility of bacteria in the cooked food than foods cooked without it. Our research shows no cooking device patent that resembles The Barbecue Top Cooker.

Problems in cooking foods on a grill or other cooking surfaces include:
1) Conventional charcoal, gas, or electric fired barbecue cookers and cook tops tend to over cook and dry out foods which contributes to loss in flavor of food.
2) Bacteria levels in grilled foods may not be at acceptable levels for consumption.
3) Flying insects getting on the surface of foods while being cooked.

### BRIEF SUMMARY OF THE INVENTION

The Barbecue Top Cooker is a device designed to cover foods close to the food item on a grill or cooking surface as the food item/s cook to retain moisture, to increase heat, to reduce harmful bacteria levels in the cooked food, and to provide a barrier from insects as food is cooked on the grill or cooking surface.

### DETAILED DESCRIPTION OF THE INVENTION

The Barbecue Top Cooker is a metal or ceramic pan of thick material with handles built into the topper or attached on the topper which can be used in conjunction with barbeque grill or grills of any kind or cook tops that creates a top that may be placed over foods being cooked to seal in heat close to the food item and retains moisture around the food item as it is cooked. The Barbecue Top Cooker may be of many different sizes and/or shapes. It is a very versatile item and can be used for marinating foods prior to cooking, carrying food items to the grill or cook top, and serving foods after cooking.

The Barbecue Top Cooker maintains uniform temperature around the food item being cooked and allows for higher temperatures for the food item to be cooked at that will reduce levels of bacteria in the cooked items to levels lower than food items cooked without it. The Barbecue Top Cooker provides a barrier from flying insects.

Charcoal or gas or electric fired barbecue grilling tends to over cook and dry out foods due to the large cubic volume of space that allows evaporation of moisture designed on most grills between the outer cover and the cooking surface and no moisture retention on conventional outdoor grills that do not have a lid at all to cover foods being cooked. Additionally, conventional inside cook tops and grills either gas or electric do not have covers for food. Moisture from foods (which contain a lot of the flavor) actually evaporate and therefore are not in the cooked food item. The Barbecue Top Cooker is a cover to use over food items while cooking that reduces the volume of space around the food item. Therefore, food items cooked using The Barbecue Top Cooker retain more moisture and flavors than foods cooked without it.

The Barbecue Top Cooker keeps and increases heat temperature close to the food items being cooked under it providing a more uniform and constant temperature thereby killing more bacteria and killing bacteria faster than by grilling or cooking without the topper.

The Barbecue Top Cooker provides a barrier against flying insects getting on food while cooking whether that be on outside or inside cooking tops or grills.

The Barbecue Top Cooker speeds the cooking process. Fuel and energy costs to cook foods using the device will be less than cooking foods without it.

### BRIEF DESCRIPTION OF THE SEVERIAL VIEWS OF THE DRAWING

Drawing shows an example of the Barbecue Top Cooker being in pan form which can be round, oblong, square., or other shape. Drawing also shows the Barbecue Top Cooker having side walls extending downwards to produce a covered and contained area that food items will be placed in that provides a small amount of cubic space around the food item as it cooks. Drawing shows handles on top of The Barbecue Top Cooker that can be used for maneuvering the Barbecue Top Cooker while cooking and lifting to check food while cooking. Although handles are shown in drawing to be attached, handles could be molded in the material instead of being attached to the Barbecue Top Cooker. Even removable handles are a possibility.

1. We claim that the idea of cooking on the grill or cooking surface with a hard material top cover designed to cover food items closely to the food item (not wrapping) in a fashion to retain moisture and flavor, protect from flying insects, reduce cooking time, save fuel, and reduce harmful bacteria is unique to the Barbecue Top Cooker and is ours.

2. We claim that the Barbecue Top Cooker will provide a barrier against flying insects while cooking food items on the grill or cooking surface.

3. We claim that the Barbecue Top Cooker will increase cooking temperature of food items on the grill or cook top while they cook.

4. We claim that food items cooked using the Barbecue Top Cooker and the air immediately surrounding the food items will maintain more constant and uniform cooking temperatures than food items cooked without it.

5. We claim that foods cooked using the Barbecue Top Cooker will retain more moisture than foods cooked without it.

6. We claim that foods cooked using the Barbecue Top Cooker will retain more flavor than foods cooked without it.

7. We claim that foods cooked using the Barbecue Top Cooker when cooked to generally recognized temperatures for the food item will have lower levels of harmful bacteria in the cooked foods than foods cooked without it.

8. We claim that the Barbecue Top Cooker when inverted provides a container for carrying food items for grilling to the grilling surface.

9. We claim that the Barbecue Top Cooker when inverted provides a container for marinating food items.

10. We claim that after cooking, the Barbecue Top Cooker inverted provides a heated container for serving cooked food.

11. We claim that the Barbecue Top Cooker can be constructed of several different types of material.

12. We claim that the Barbecue Top Cooker can be made in various shapes and configurations that will provide a cover over food items as they cook on grills or other cooking surfaces.

13. We claim that the Barbecue Top Cooker can have handles of various shapes and material that will not melt in high temperatures.

14. We claim that the Barbecue Top Cover is effective for vegetables, meats, and seafoods.
